(19) United States
(12) Patent Application Publication
(10) Pub. No.: US 2026/0195247 A1
(43) Pub. Date: Jul. 9, 2026

(54) USING ARTIFICIAL INTELLIGENCE (AI) TO FILTER TEST CASES

(71) Applicant: International Business Machines Corporation, Armonk, NY (US)

(72) Inventors: Hai Feng Yao, Shanghai (CN); Jun Ming Guan, Shanghai (CN); Huai Ying Xia, Beijing (CN); Jing Chen, Shanghai (CN); Min Huang, Shanghai (CN); Jing Ran Yang, Shanghai (CN)

(21) Appl. No.: 19/011,274

(22) Filed: Jan. 6, 2025

(51) Int. Cl. G06F 11/3668

(52) U.S. Cl. CPC G06F 11/3688

(57) ABSTRACT

A method, according to one embodiment, includes causing a first artificial intelligence (AI) analysis model to analyze a collection of historical data about a computer code, where an output of the first AI analysis model details calculations of priorities of test cases of the computer code. The method further includes causing a first AI selection model to filter a first portion of the test cases from the test cases to establish a second portion of the test cases, where the filtering is based on the calculated priorities, execution times of the test cases, and determined coverages of the test cases. The method further includes causing the second portion of the test cases to be run. A computer program product, according to another embodiment, includes one or more computer readable storage media, and program instructions stored on the one or more storage media to perform the foregoing method.

### BACKGROUND

The present invention relates to artificial intelligence (AI), and more specifically, this invention relates to test cases.

Build verification testing, commonly known as BVT, typically relies on a set of fixed functional test scripts. Build verification testing enables computer code to be tested prior to deploying the computer code. This way, in the event that an error is determined to be present in the computer code, which may occur based on an update being performed on the computer code, corrective actions may be performed to mitigate the error before deployment. In continuous integration and continuous delivery (CICD), build verification testing is run upon code submission.

### SUMMARY

A method, according to one embodiment, includes causing a first artificial intelligence (AI) analysis model to analyze a collection of historical data about a computer code, where an output of the first AI analysis model details calculations of priorities of test cases of the computer code. The method further includes causing a first AI selection model to filter a first portion of the test cases from the test cases to establish a second portion of the test cases, where the filtering is based on the calculated priorities, execution times of the test cases, and determined coverages of the test cases. The method further includes causing the second portion of the test cases to be run.

A computer program product, according to another embodiment, includes one or more computer readable storage media, and program instructions stored on the one or more storage media to perform the foregoing method.

A computer system, according to another embodiment, includes a processor set, one or more computer readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a representation of an infrastructure, in accordance with one embodiment of the present invention.

FIG. 4 is a flowchart of a method, in accordance with one embodiment of the present invention.

FIGS. 5A-5B are depictions of a database, in accordance with several embodiments.

FIGS. 6A-6B depict tables, in accordance with several embodiments.

FIG. 7 depicts a table, in accordance with one embodiment of the present invention.

FIG. 8 depicts a table, in accordance with one embodiment of the present invention.

FIG. 9 depicts a table, in accordance with one embodiment of the present invention.

FIG. 10 depicts a table, in accordance with one embodiment of the present invention.

FIG. 11 depicts an equation, in accordance with one embodiment of the present invention.

FIG. 12 is a flowchart of a method, in accordance with one embodiment of the present invention.

FIG. 13 is a progression of filtration being applied to test cases, in accordance with one embodiment of the present invention.

FIG. 14 is a flowchart of a method, in accordance with one embodiment of the present invention.

FIG. 15 is a depiction of a modeling 1500, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using AI to filter test cases.

In one general embodiment, a method includes causing a first AI analysis model to analyze a collection of historical data about a computer code, where an output of the first AI analysis model details calculations of priorities of test cases of the computer code. The method further includes causing a first AI selection model to filter a first portion of the test cases from the test cases to establish a second portion of the test cases, where the filtering is based on the calculated priorities, execution times of the test cases, and determined coverages of the test cases. The method further includes causing the second portion of the test cases to be run.

In another general embodiment, a computer program product includes one or more computer readable storage media, and program instructions stored on the one or more storage media to perform the foregoing method.

In another general embodiment, a computer system includes a processor set, one or more computer readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as test case filtering code of block 150 for using AI to filter test cases. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

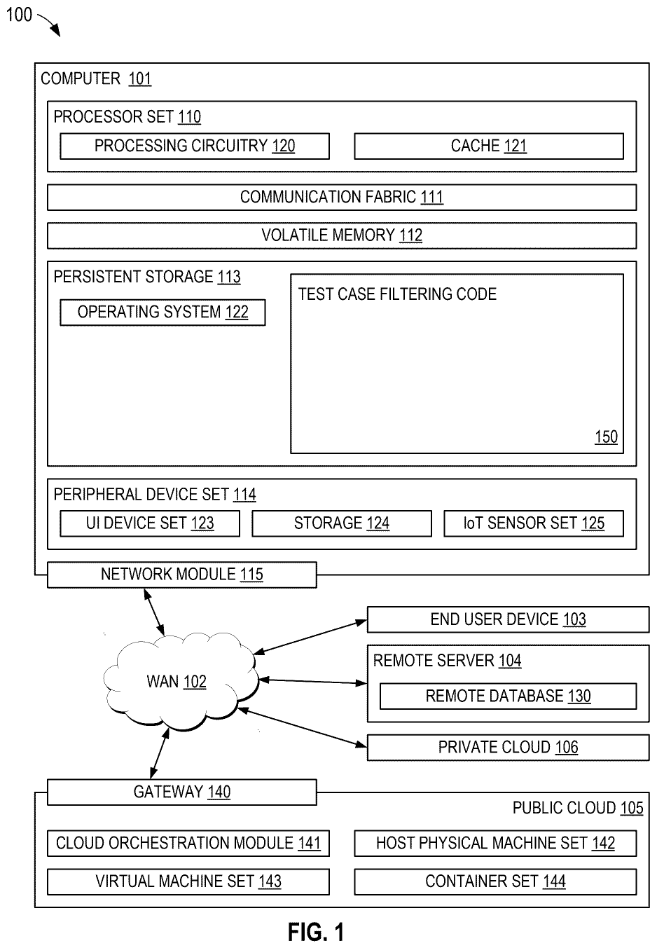

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, build verification testing, commonly known as BVT, typically relies on a set of fixed functional test scripts. Build verification testing enables computer code to be tested prior to deploying the computer code. This way, in the event that an error is determined to be present in the computer code, which may occur based on an update being performed on the computer code, corrective actions may be performed to mitigate the error before deployment.

In continuous integration and continuous delivery (CICD), build verification testing is run upon code submission. However, several issues occur in an actual project based on this timeline. A first of these issues includes static build verification testing test cases not efficiently testing the computer code and not focusing on the actual changes made to the computer code. Sometimes, even with a relatively small code change, a full set of fixed build verification testing test cases is executed. This can be relatively time consuming. Another of these issues includes fixed build verification testing test scripts not covering some build issues caused by new features incorporated into the computer code. To avoid unnecessary test runs and save spending associated with test servers, the techniques of embodiments and approaches described herein minimize testing efforts by identifying a relatively most concise set of test cases for specific change sets made to computer code.

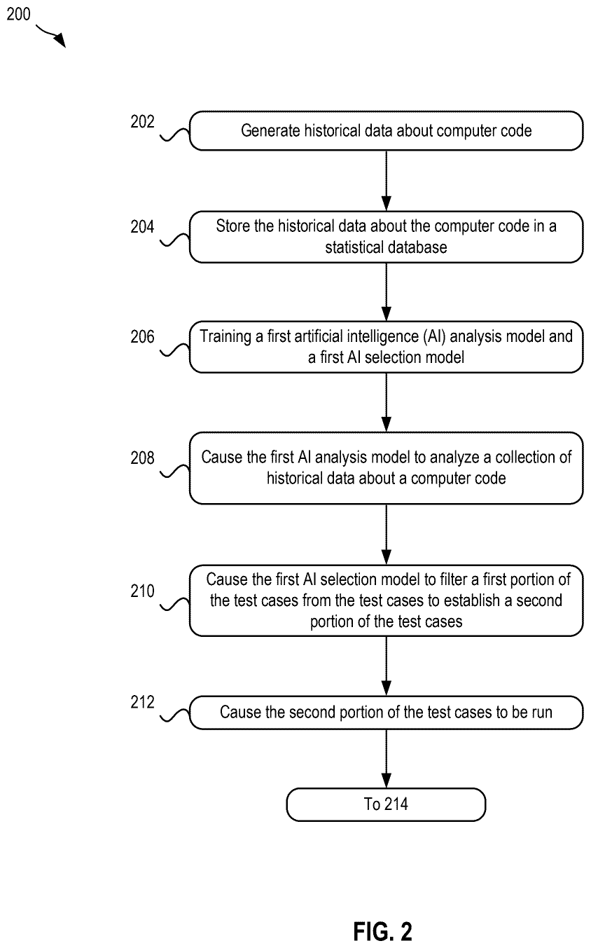

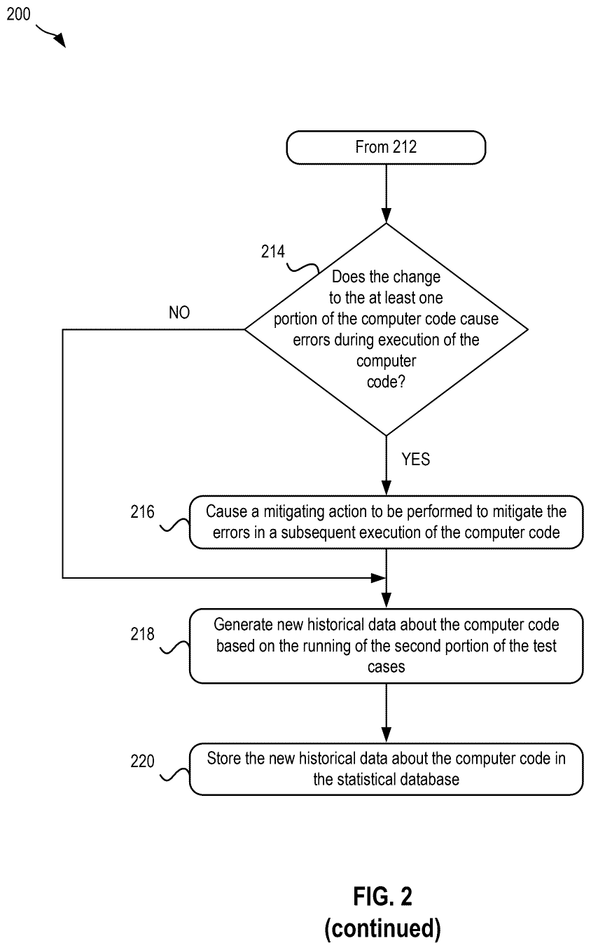

Now referring to FIG. 2, a flowchart of a method 200 is shown according to one embodiment. The method 200 may be performed in accordance with aspects of the present invention in any of the environments depicted in FIGS. 1-15, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, in some approaches, operations of method 200 may be performed with respect to a type of computer code that would become apparent to one of ordinary skill in the art after reading the descriptions herein. In some approaches, the computer code is function code. Furthermore, in some approaches, the computer code may additionally and/or alternatively be a type of code that can ongoing be updated. For example, one or more portions of the computer code may be updated and then distributed to customer user devices once a determination is made that the updated computer code passes testing (to ensure that the update does not create runtime errors, comparability errors among different portions of the code, etc.). To provide further context to the embodiments and approaches described herein, the computer code may include test cases of a type that would become apparent to one of ordinary skill in the art after reading the descriptions herein. At least some of these test cases may, in some approaches, be configured to be independently run, run in parallel, run sequentially, run in batches, etc. For example, as described in detail below, in preferred approaches, a subset the test cases may be determined and run, while another subset of the test cases are not run (for reducing an extent of processing resources that are expended in testing subsequent to an update being made to the computer code). Note that, depending on the approach, the updates made to the computer code may include updates made to test cases of the computer code and/or made to portions of the computer code that are not test cases.

Operation 202 includes generating historical data about the computer code. In some approaches, the historical data is performance data generated based the computer code being run, e.g., running the test cases of the computer code. This running of the computer code, in some approaches, includes performing an initial run of all of the test cases, e.g., running all of the test cases in a single testing session, running all of the test cases within a predetermined period of time, etc. Results of running the test cases make up the historical data, in some approaches. Accordingly, the historical data about the computer code may, in some approaches, be stored in a statistical database, e.g., see operation 204.

In one preferred use case example, generating historical data about the computer code includes performing a predetermined historical data gathering process. The predetermined historical data gathering process includes instrumenting the computer code with a coverage counter of a type that would become apparent to one of ordinary skill in the art after reading the descriptions herein. Thereafter, in some approaches, a full test of the test cases of the computer code is initially run. Alternatively, only the test cases of the computer code that are changed (based on code and/or configuration changes) may be run in this step of the predetermined historical data gathering process. Functional code execution for the test cases may be recorded as (at least a portion of) the historical data. Associations between the test cases and function code may be determined based on execution of the computer code during the testing. These associations may, in some approaches, be made based on test and/or function code relationships (e.g., relationships between test files and/or test cases and function code files) using techniques that would become apparent to one of ordinary skill in the art after reading the descriptions herein. Furthermore, a function code coverage and test case priority may be calculated by AI models using techniques that are described in greater detail elsewhere herein. In some approaches, the historical data about the computer code is specifically generated based on the recording, associating and calculation steps mentioned above, e.g., information about these steps of the predetermined historical data gathering process is saved to the statistical database).

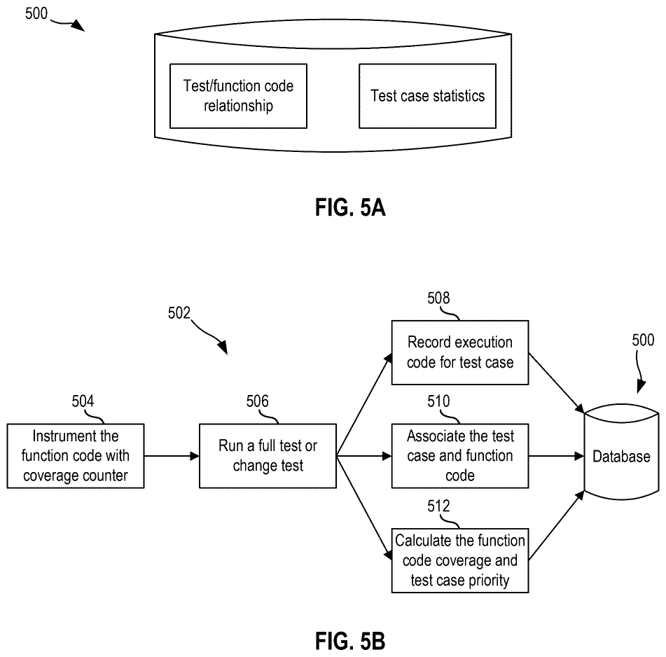

The predetermined historical data gathering process is described in further detail elsewhere herein, e.g., see FIG. 5B.

The historical data about the computer code may include one or more type of data, which may depend on the use case and/or environment that the computer code is scheduled to be deployed in and/or currently deployed in. In some approaches, the historical data about the computer code includes past runtimes for the test cases, dates that the test cases were previously run, test case priority data, and test case relationship data. In some other approaches, the historical data about the computer code additionally and/or alternatively includes pass and/or fail statistics for previous runs of the test cases, lines of the computer code that the test cases are located at, a test case heat map (that details a number of times each test case has been run), etc.

Operation 206 includes training a first artificial intelligence (AI) analysis model to analyze collections of historical data about computer codes and training a first AI selection model to perform filtering on test cases to establish a portion of the test cases to run.

This training, in some approaches, includes using a first training set of data to train the first AI analysis model to analyze a collection of test data. The first AI selection model is, during this training, caused (e.g., instructed) to output calculations that include priorities of test cases of a computer code that the training set of data is based on. It should be noted that specifics of these calculations are described in greater detail elsewhere herein, e.g., see operation 208. Initial training of one or both of these AI models may include reward feedback that may, in some approaches, be implemented using a subject matter expert (SME) that generally understands whether the model makes a correct initial guess. However, to prevent costs associated with relying on manual actions of a SME, in another approach, reward feedback may be implemented using techniques for training a BERT model, as would become apparent to one skilled in the art after reading the present disclosure. In response to a determination that the first AI analysis model achieves at least a predetermined threshold of accuracy, the first AI analysis model is deployed to analyze the collection of historical data about the computer code. Similarly, a second training set of data may be used to train the first AI selection model to perform filtering, e.g., filtering on test cases of the computer code that the training set of data is based on, to establish a portion of the test cases to run. It should be noted that specifics of this filtering is described in greater detail elsewhere herein, e.g., see operation 210. In response to a determination that the first AI selection model achieves at least the predetermined threshold of accuracy, the first AI selection model is deployed to filter a first portion of the test cases from the test cases of the computer code to establish a second portion of the test cases, as will be described in greater detail elsewhere below.

It should be noted that the first training set of data and the second training set of data are preferably different training sets of data with no overlap. In other words, the second training set of data is not an updated version of the first training set of data. Accordingly, the first AI analysis model and the first AI selection model are different models entirely, that may be run simultaneously.

The first AI analysis model is caused to analyze the collection of historical data about the computer code, e.g., see operation 208. In some approaches, the first AI analysis model is caused to analyze the collection of historical data about the computer code in response to at least one portion of the computer code being changed. In some other approaches, the first AI analysis model is caused to periodically analyze the collection of historical data about the computer code. In some other approaches, the first AI analysis model is caused to analyze the collection of historical data about the computer code in response to a determination that a configuration change has been made, e.g., a change is made to one or more of the configuration files associated with the computer code. In some other approaches, the first AI analysis model may additionally and/or alternatively be caused to analyze the collection of historical data about the computer code in response to a determination that dependencies within the computer code are being changed.

An output of the first AI analysis model, in some preferred approaches, details calculations of priorities of test cases of the computer code. In other words, the first AI analysis model is caused to determine priorities of test cases based on the collection of historical data about the computer code. Techniques for determining these priorities are described below.

The priorities of the test cases of the computer code are, in some approaches, calculated based on variables selected from the group including failure point values based on past execution failures of the test cases, critical path values based on code lines (numbers of) that the test cases are associated with, and configuration change values of configuration files associated with the test cases. In some approaches, the variables may additionally and/or alternatively include customized setting values of the test cases.

The priorities of the test cases of the computer code are, in some preferred approaches, calculated based on a plurality of the variables. Different dynamically adjustable weightages may, in some approaches, be applied to at least some of the variables. An equation that may, in some approaches, be used to determine the priorities of a given one of the test cases is provided below.

Priority=FPV×weight1+CPV×weight2+CCV×weight3+CSV×weight4 Equation (1)

In Equation (1), the variable FPV represents the failure point value of the given test case based on past execution failures of the given test case. The variable CPV represents the critical path value of the given test case which is based on the number of code lines that the given test cases is associated with. Furthermore, the variable CCV represents the configuration change value of configuration files associated with the given test case. Finally, in Equation (1), the variable CSV represents the customized setting value that may be assigned to the given variable based on input received from a user device. The variables that the priorities of the test cases may be based on are described in further detail below.

The failure point value variable may, in some approaches, be based on historical occurrence of failures during performance of the test cases. These reported failures may, for example, be based on the test cases (and/or portions of the computer code that the test cases test) including bugs as a result of one or more updates being made to the computer code. Reported failures may, in some approaches, be documented in the collection of historical data about a computer code. This way, the first AI analysis model may be caused, e.g., instructed, to parse this failure point value data to generate values for the failure point value variables (hereafter also referred to as “failure point values”). In order to generate these failure point values, in some approaches, the first AI analysis model assigns relatively greater failure point values to test cases with relatively more recently reported failures, and relatively lesser failure point values to test cases with relatively less recently reported failures. A temporal assignment scheme may be deployed that considers these reported failures within predetermined increments of time. For example, test cases with relatively most recently reported bugs, e.g., within the last seven days, may be assigned a relatively greatest failure point value, e.g., a failure point value of 100 out of 100. Prioritization (by assignment of relatively greatest failure point values) of test cases having recent failures promotes the testing of test cases that are relatively more likely to fail. Otherwise testing test cases with a relatively low likelihood of failing amounts to a waste of processing resources, as this testing does not promote discovery of problematic portions of the computer code. The temporal assignment scheme may additionally and/or alternatively assign relatively lesser weights to test cases that do not have reported bugs within the last seven days. For example, test cases that have reported bugs within the last thirty days (but not within the last seven days) may be assigned a failure point value of fifty (out of a possible 100 failure point value). In yet another example, test cases that have reported bugs within the last 180 days (but not within the last thirty days) may be assigned a failure point value of two (out of a possible 100 failure point value). Finally, all other test cases that do not fall within the predetermined increments of time mentioned above may be assigned a failure point value of one (out of a possible 100 failure point value). These failure point values may, in some approaches, be stored to the statistics database.

The critical path value variable of a test case may, in some approaches, be based on a number of functional code lines that the test case is located across. In some approaches, in order to determine the critical path value of a given test case, method 200 may include causing a mask of a functional code line counter that is to be executed by all test cases runs. A calculation may then be performed to determine an ordering of the test cases according to a number of lines that the test case is located across, e.g., ordered from a first of the test cases that runs relatively more code lines than the other test cases to an n^{th} of the test cases that runs relatively less code lines than the other test cases. Values may then be assigned to the test cases based on this ordering, e.g., where test cases with relatively less code lines are assigned relatively greater critical path values than test cases with relatively more code lines. This assignment ensures that relatively more condensed test cases are prioritized. However, it should be noted that in order to ensure that the scope of testing that is performed remains robust, in some approaches, this assignment is only performed to test cases of the same type of variable, e.g., to filter out redundant tests.

In preferred approaches, the assignment of critical path values may be based on determinations of which test cases have a critical path coverage index base weight. Here the test cases with relatively most critical paths are assigned relatively higher critical path values, e.g., a rating of 100, while the test cases with relatively least critical paths are assigned relatively lower critical path values, e.g., a rating of one. In some approaches, these critical path values may be based on the type of test case. For example, test cases based on login and/or authorization based functional code may be assigned a highest rating (of 100), while test cases that involve a new ordering of the functional code may be assigned relatively less rating (e.g., fifty), and test cases involving failures to properly perform a login and/or authentication are assigned a relatively lowest rating (e.g., code involving procedures for responding to a failures to properly enter an authorization entity are assigned a rating of one).

The configuration value variable of a test case may, in some approaches, be based on extents that configuration files (that the test cases test) change as a result of at least one portion of the computer code being changed. More specifically, the computer code may be broken down into different portions according to different configuration files that the different portions are associated with. For example, these configuration files may include, e.g., a dockerfile, a module file such as JavaScript npmpackage.json, a database schema, etc. Test cases associated with configuration files that have a greater extent of change are assigned relatively greater configuration values, while test cases associated with configuration files that have a lesser extent of change are assigned relatively lesser configuration values.

In some approaches, more than one of the test cases may be associated with the same configuration file. In such approaches, each of the test cases associated with the same configuration file may be assigned the same configuration value variable. In contrast, in some other approaches, each test case is assigned a unique configuration value variable (regardless of whether a plurality of test cases are associated with the same configuration file).

The customized setting value variable of a test case may, in some approaches, be based on input and/or feedback received from a user device, e.g., adjustment factors manually set user device input and/or feedback. In some approaches, the customized setting value variable incorporates additional context into the determination of the priorities of the test cases. For example, input received from a user device may provide an indication of which portions of the computer code are to be used next, and therefore test cases associated with these portions of the computer code may be assigned relatively greater customized setting values than other test cases that are not associated with these portions of the computer code. In another example, feedback received from a user device may provide an indication of features of an application associated with the computer code are experiencing issues and therefore should be addressed in a next testing sequence of the computer code. In such an example, test cases associated with these application features may be assigned relatively greater customized setting values than other test cases that are not associated with these application features.

Operation 210 of method 200 includes causing a first AI selection model to filter a first portion of the test cases from the test cases to establish a second portion of the test cases (a remainder of the test cases that are not filtered-out). In some preferred approaches, the filtering is based on the calculated priorities. Test cases with relatively greater priority scores, e.g., calculated using Equation (1), are preferably not filtered-out, while test cases with relatively lower priority scores are preferably filtered-out. In some approaches, a predetermined portion of the test cases are filtered-out (with relatively lowest priorities) while a remainder of the test cases that are not filtered-out establish the second portion of the test cases.

The filtering may, in some approaches, be additionally and/or alternatively based on execution times of the test cases. The execution times of the test cases may be determined based on previous runtime information in the collection of historical data. In some approaches, test cases with relatively lower runtimes are prioritized (not filtered-out), while test cases with relatively greater runtimes are not prioritized (filtered-out). In some approaches, the determination of which test case to filter-out based on execution times is performed with respect to the same configuration file. In other words, in such approaches, where more than one of the test cases are associated with a given configuration file, filtering performed with respect to execution times of the test cases may be performed with respect to the test cases are associated with the given configuration file. Meanwhile, in such an approach, configuration files that are only associated with a single one of the test cases are not filtered-out and/or are assigned relatively higher weights so as to cause test cases associated with at least a majority of the configuration files to survive the filtering.

In some approaches, the filtering may additionally and/or alternatively be based on the determined coverages of the test cases. For context, in order to ensure that a relatively broad scope of testing is performed on the computer code, in some approaches, the filtering may prioritize test cases with relatively boarder coverage than test cases with relatively narrower coverage. For further context, the term “coverage” defines what percentage of the computer code is tested by a given test case. Accordingly, the filtering may cause portions of the computer code with redundant test case coverage to be prioritized for having at least some of the redundant test cases filtered-out, while portions of the computer code with only a single test case testing the portions may be prioritized for not being filtered-out.

In some approaches, test cases that are filtered out are each assigned a predetermined value of additional priority in a subsequent determination of which test cases to filter-out. This additional priority may be accrued over time, e.g., over a series of iterations of method 200. This way, test cases that have relatively low priority may, in some approaches, eventually be run. However, the it should be noted that this additional priority may be negated by the customized setting values of the test cases, e.g., user device input and/or feedback may prevent some test cases from ever being run.

Operation 212 includes causing the second portion of the test cases to be run, while the first portion of the test cases are not run. The second portion of the test cases may be caused to be run by issuing instructions to a testing engine of a type that would become apparent to one of ordinary skill in the art after reading the descriptions herein. Method 200 includes determining, based on results of running the second portion of the test cases, whether the change to the at least one portion of the computer code causes errors during execution of the computer code, e.g., see decision 214. This determination may, in some approaches, be based on a runtime log that details whether one or more predetermined events have occurred, e.g., crashes occurring during execution of one or more of the test cases, bugs being identified during execution of one or more of the test cases, null value returns occurring during execution of one or more of the test cases, a formatting issue occurring on an application associated with the computer code, etc.

In response to a determination that the change to the at least one portion of the computer code does not cause errors during the execution of the computer code, e.g., as illustrated by the “NO” logical path of decision 214, method 200 optionally continues to operation 218. In contrast, in response to a determination that the change to the at least one portion of the computer code causes errors during the execution of the computer code, e.g., as illustrated by the “YES” logical path of decision 214, a mitigating action is caused to be performed to mitigate the errors in a subsequent execution of the computer code, e.g., see operation 216. The mitigating action may be of a type that would become apparent to one of ordinary skill in the art after reading the descriptions herein. In one approach, the mitigating action includes performing a rollback of the computer code until a fix is generated and incorporated into a subsequent change of the computer code. In another approach, the mitigating action includes allowing use of portions of the computer code that are not associated with the test cases that the errors are identified by, but not allowing use of other portions of the computer code.

Operation 218 includes generating new historical data about the computer code based on the running of the second portion of the test cases. The new historical data may, in some approaches, include runtime information, timestamps, whether errors were identified by the test case, whether any of the test cases failed, etc. In some preferred approaches, at least some of the new historical data is of the same type as the historical data that the that the first AI analysis model used to generate the output that details the calculations of the priorities of the test cases of the computer code. This way, the collection of historical data is kept up to date over time. The new historical data about the computer code is stored in the statistical database, e.g., see operation 220.

In some approaches, batch testing may be performed by other AI models to determine whether the first AI selection model and the second AI selection model are operating efficiently. For example, method 200 may, in some approaches, include causing a second AI selection model to filter a third portion of the test cases from the test cases to establish a fourth portion of the test cases. The second AI selection model may be trained using similar techniques to those described herein for training the first AI selection model. However, the second AI selection model preferably applies different kernel functions and adjusted parameters than the first AI selection model. A determination may be made as to which of the first AI selection model and the second AI selection model establishes a relatively most efficient portion of the test cases to be run. For context, a relatively most efficient portion of the test cases being run may, in some approaches, be identified as the test cases having a relatively shortest runtime. In some other approaches, a relatively most efficient portion of the test cases being run may, in some approaches, result in a greatest number of errors being identified in the computer code. In yet another approach, the relatively most efficient portion of the test cases being run may be based on a number of factors, e.g., the relatively shortest run time provided that the test cases of the relatively shortest runtime identify all of the errors identified by the other test cases being run.

Method 200 includes deploying the determined AI selection model for a subsequent filtering of the test cases. In order to prevent the batch testing described above from reducing the efficiencies (e.g., preserved processing potential) enabled by running a portion of the test cases, in some approaches, this batch testing is performed in response to a determination that additional processing resources (of a processing circuit performing method 200) are going to be available for a period of time, e.g., during forecasted periods of low processing expenditure. This way, accuracies of the AI models are ongoingly refined without incurring an additional processing load (without using the processing resources that are preserved by the analysis of the first AI analysis model and the first AI selection model).

In order to further refine subsequent iterations of the operations of method 200, in some approaches, method 200 includes adjusting the weightages based on results of running the second portion of the test cases. These adjustments may be performed based on results of the batch testing described above. For example, in response to a determination that the filtering of the third portion of the test cases from the test cases results in relatively greater efficiencies, the weightages may be adjusted, at least a predetermined amount, to adhere to priorities applied by the second AI selection model.

Various benefits are enabled within the technical field of computing as a result of deploying the techniques of embodiments and approaches described herein. These benefits are enabled as these techniques achieve a broad test case scope coverage while only using a portion of available test cases. This reduced test case workload relatively shortens an entire test execution time, and also considers an impact of configuration change, dependency change, etc., on a build and a functionality of the computer code.

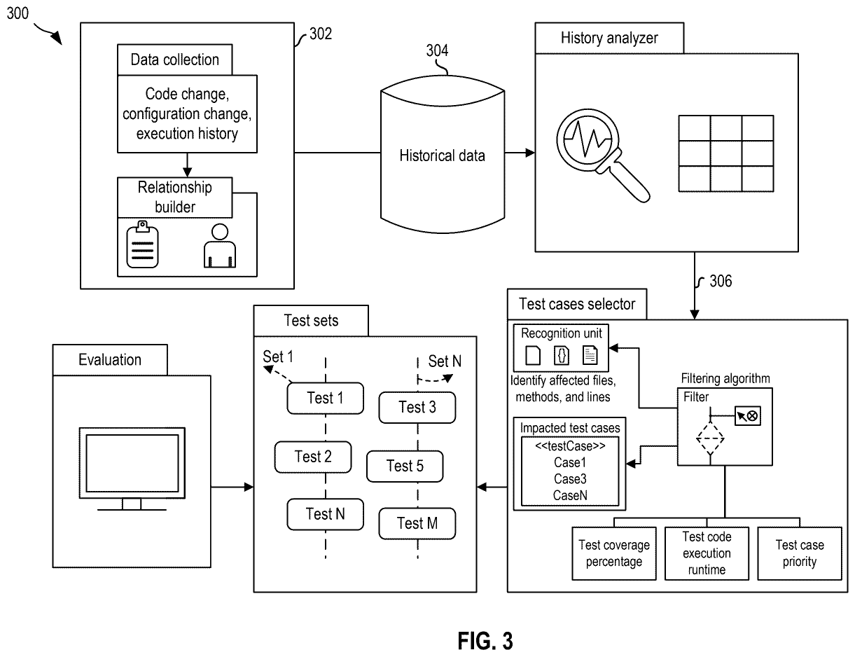

FIG. 3 depicts an infrastructure 300, in accordance with one embodiment. As an option, the present infrastructure 300 may be implemented in conjunction with features from any other embodiment listed herein, such as those described with reference to the other FIGS. Of course, however, such infrastructure 300 and others presented herein may be used in various applications and/or in permutations which may or may not be specifically described in the illustrative embodiments listed herein. Further, the infrastructure 300 presented herein may be used in any desired environment.

The infrastructure includes a collection of historical data stored in a database 304. The historical data may be collected by a collection engine 302 of a type that would become apparent to one of ordinary skill in the art after reading the description herein. This engine may be configured to interact with user devices, e.g., see relationship builder, to log data in response to a predetermined event occurring, e.g., code change, configuration change, execution history, etc. In some approaches, the historical data is created for the computer code in response to a determination that a predetermined event has occurred, e.g., creation of a test selection data store based on code change, configuration change, execution history, test cases, etc.

A first AI analysis model, e.g., see history analyzer, is caused to analyze the collection of historical data about a computer code. An output of the first AI analysis model, e.g., see output 306, details calculations of priorities of test cases of the computer code. Thereafter, a first AI selection model, e.g., see test case selector, is caused to filter (e.g., using a predetermined filtering algorithm) a first portion of the test cases from the test cases to establish a second portion of the test cases (a remainder of the test cases that are not filtered-out). In some approaches, the filtering is based on the calculated priorities, e.g., see test case priority. The filtering may additionally and/or alternatively be performed based on execution times of the test cases, e.g., see test code execution runtime. The filtering may additionally and/or alternatively be performed based on determined coverages of the test cases, e.g., see test coverage percentage. In some approaches, the second portion of the test cases include test cases that are impacted by the change to the computer code, e.g., see impacted test cases and recognition unit which identifies affected files, methods and lines of the computer code.

In some approaches, the first AI analysis model is a test case history records analyzer, which is used to collect each test case's running properties, e.g., such as running times, how many function codes and/or files have been executed, files and associated times, etc. The analyzer may additionally and/or alternatively collect and/or analyze every code line of the computer code, a code block of the computer code, a code file that every test cased involved, etc. For context, in these approaches, the AI analyzer may be built and trained to provide information to a selection model that is caused to filter out relatively least compact sets of test cases based on the priority, execution time and coverage. For example, this information may include determined priority information based on failure point values, critical path values, the number of code lines covered by a test case, a significance of the functions addressed, and more.

An illustration of the filtering of the test cases is shown in the test sets portion of the infrastructure. For example, test case 3, test case 5 and test case M are shown to be filtered out, while test case 1, test case 2, and test case N of a second portion of the test cases (Set 1) are shown to proceed to an evaluation engine, e.g., see evaluation. The evaluation engine may be configured to run the second portion of the test cases and, in some approaches, provide feedback to the AI models about an outcome of running the test cases.

Using the techniques described above, whenever a change occurs within a changeset of the computer code (code change, configuration change, dependencies change etc.), a mapping table that defines the determinations of the models (priority, execution history, a group of test case set that covers all changes, etc.) is immediately identified.

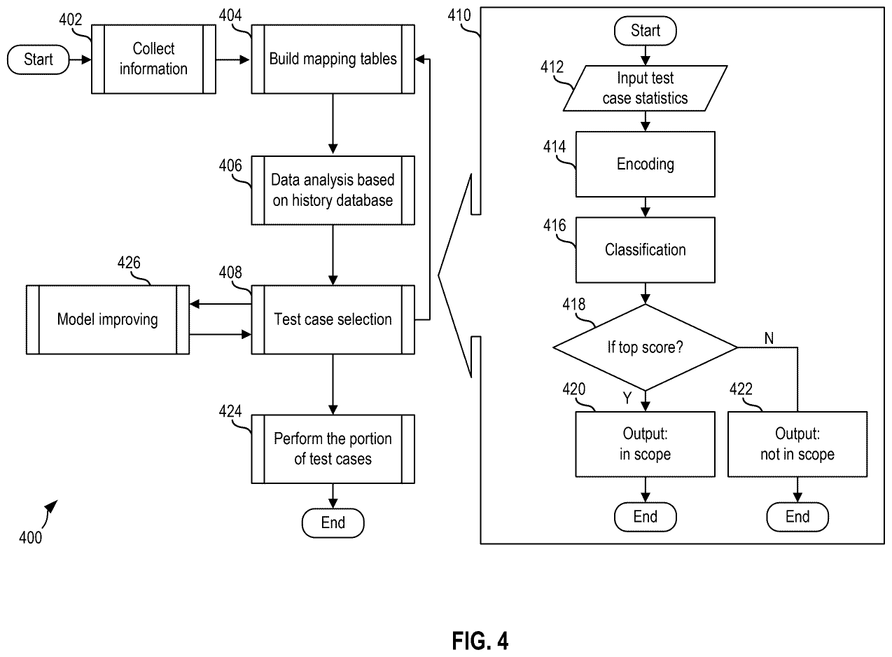

Now referring to FIG. 4, a flowchart of a method 400 is shown according to one embodiment. The method 400 may be performed in accordance with aspects of the present invention in any of the environments depicted in FIGS. 1-15, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 400 includes similar operations to the operations of method 200.

Method 400, in some approaches, includes collecting historical data about a computer code, e.g., see operation 402. The historical data may be stored to a database, and in some approaches, is organized, e.g., see operation 404. This organization may include building mapping tables that identifies interrelationships among test cases of the computer code, where the interrelationships may be of a type that would become apparent to one of ordinary skill in the art after reading the descriptions herein.

A first AI analysis model is caused to analyze the collection of historical data about the computer code, e.g., see operation 406, where an output of the first AI analysis model details calculations of priorities of test cases of the computer code. This output may be fed into a first AI selection model to filter a first portion of the test cases from the test cases to establish a second portion of the test cases, e.g., see test case selection of operation 408. A plurality of sub-operations 410 of operation 408 may, in some approaches, be performed in order to determine the second portion of the test cases. For example, the sub-operations include causing the first AI selection model to accept input of test case statistic based historical data, e.g., see sub-operation 412. The first AI selection model may be caused to perform encoding and/or classification of the historical data for determining which of the test cases to filter out in a next collection of test cases that are run, e.g., see sub-operation 414 and sub-operation 416. The classifications, in some approaches, include evaluating priorities and/or other information about the test cases to establish the second portion of the test cases. This second portion of the test cases may include a predetermined number of the test cases with relatively highest scores, e.g., see sub-operation 418 which filters-out test cases not within the scope of priority (see sub-operation 422) and keeps test cases within the scope of priority (see sub-operation 420).

Operation 424 includes performing the test cases of the second portion of the test cases. In some approaches, feedback is provided to one or more of the models to increase an accuracy of the models, e.g., see operation 426.

FIGS. 5A-5B depict a database 500, in accordance with several embodiments. As an option, the present database 500 may be implemented in conjunction with features from any other embodiment listed herein, such as those described with reference to the other FIGS. Of course, however, such database 500 and others presented herein may be used in various applications and/or in permutations which may or may not be specifically described in the illustrative embodiments listed herein. Further, the database 500 presented herein may be used in any desired environment.

Referring first to FIG. 5A, the database is shown to includes a collection of historical data about a computer code. The historical data, in some approaches, includes test/function code relationship data of a type described herein and/or that would become apparent to one of ordinary skill in the art after reading the descriptions herein. In one or more of such approaches, the database acts as a test selection data store, which has a data table to contain the functional code and test code relationship at the file, method, and lines level.

The historical data may additionally and/or alternatively include test case statistics data of a type described herein and/or that would become apparent to one of ordinary skill in the art after reading the descriptions herein. In some approaches, the database serves as a data store and includes a data table to record the test code execution data in a test suite and test case level (such as the seconds that each test case takes to be performed). The data table also includes test case priority data, in some approaches.

Referring now to FIG. 5B, the database is shown being fed by a workflow 502 of operations for obtaining historical information about the computer code. In some approaches, the workflow 502 includes deploying a coverage counter on the computer code, where the computer code is function code, e.g., see operation 504. An initial run of all of the test cases may additionally and/or alternatively be performed in order to generate the historical data, e.g., see operation 506. Results of this initial run of the test cases may be processed in parallel in order to refine and/or organize the historical data. For example, this processing may, in some approaches, include recording information about the execution of the test cases, e.g., see operation 508. The processing may additionally and/or alternatively include performing associations between the historical data (such as associations between test cases and configuration files), e.g., see operation 510. The processing may additionally and/or alternatively include calculating priorities and/or coverage (e.g., see operation 512) using techniques described elsewhere herein (see method 200).

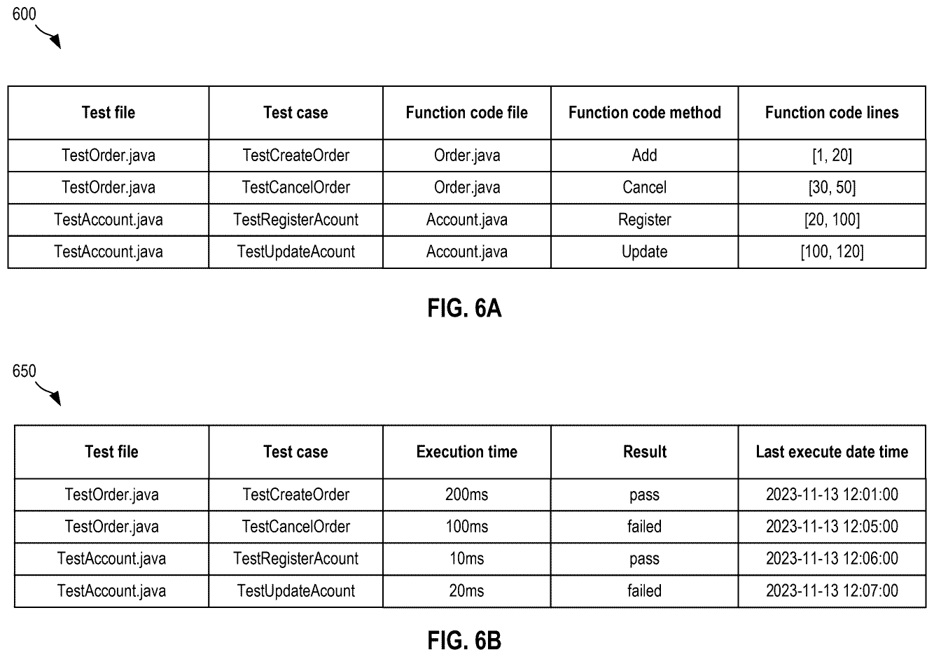

FIGS. 6A-6B depict tables 600 and 650, in accordance with several embodiments. As an option, the present tables 600 and 650 may be implemented in conjunction with features from any other embodiment listed herein, such as those described with reference to the other FIGS. Of course, however, such tables 600 and 650 and others presented herein may be used in various applications and/or in permutations which may or may not be specifically described in the illustrative embodiments listed herein. Further, the tables 600 and 650 presented herein may be used in any desired environment.

Referring first to FIG. 6A, the table 600 includes organized historical data about a computer code. More specifically, the table 600 includes historical data that details test and/or function code relationships, e.g., see indications of code lines, indications of the files that the test case are located in, etc.

Referring now to FIG. 6B, the table 650 includes organized historical data about a computer code. More specifically, the table 600 includes historical data that details statistics about test cases. These statistics, in some approaches, include a time that each test case was last run (Last execute date time), runtime information (execution time), results of the previous tests (pass or fail), etc.

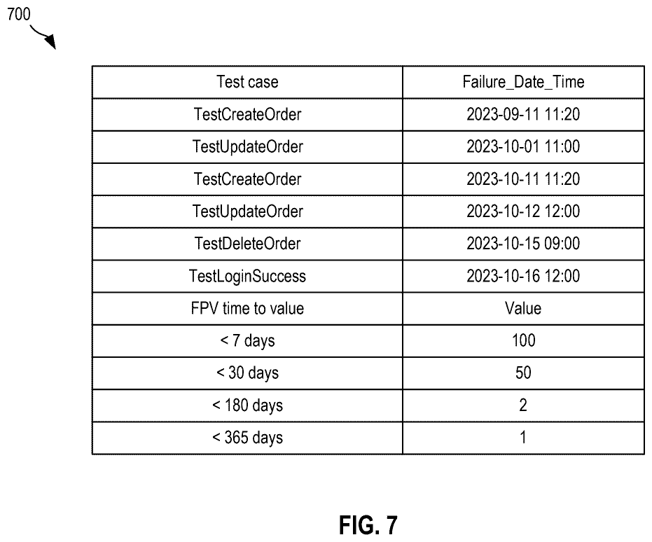

FIG. 7 depicts a table 700, in accordance with one embodiment. As an option, the present table 700 may be implemented in conjunction with features from any other embodiment listed herein, such as those described with reference to the other FIGS. Of course, however, such table 700 and others presented herein may be used in various applications and/or in permutations which may or may not be specifically described in the illustrative embodiments listed herein. Further, the table 700 presented herein may be used in any desired environment.

The table 700, in some approaches, includes information that defines failure point value variables of the test cases. For example, during execution of the test cases, reported failures (e.g., bugs) may be logged in the table 700, which may be stored in a historical statistics database. During assignment of failure point values to the test cases, a temporal assignment scheme may be deployed in which relatively lesser weights are assigned to test cases that do not have reported bugs within the last seven days. For example, test cases that have reported bugs within the last thirty days (but not within the last seven days) may be assigned a failure point value of fifty (out of a possible 100 failure point value). In yet another example, test cases that have reported bugs within the last 180 days (but not within the last thirty days) may be assigned a failure point value of two (out of a possible 100 failure point value). Finally, all other test cases that do not fall within the predetermined increments of time mentioned above may be assigned a failure point value of one (out of a possible 100 failure point value).

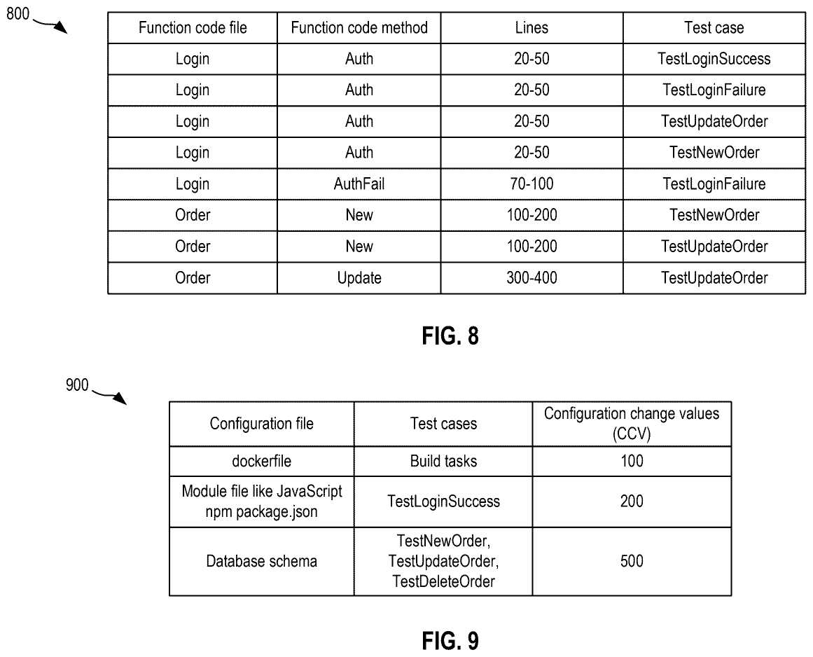

FIG. 8-9 depict tables 800 and 900, in accordance with several embodiments. As an option, the present tables 800 and 900 may be implemented in conjunction with features from any other embodiment listed herein, such as those described with reference to the other FIGS. Of course, however, such tables 800 and 900 and others presented herein may be used in various applications and/or in permutations which may or may not be specifically described in the illustrative embodiments listed herein. Further, the tables 800 and 900 presented herein may be used in any desired environment.

Referring first to FIG. 8, the table 800 includes critical path values for test cases of different function code files. In some approaches, a functional code line counter is masked during runs of the test cases, and then calculations are performed to order the test cases based on the number of code lines that the test cases are located across. Corresponding test case priority is marked based on these calculations. This way, the test cases have critical path coverage index base weights, and ranking may be applied based on determined critical paths, e.g., the most critical path has a rating of 100 and the lowest critical path has a rating of 1. Critical path values may then be calculated based on these critical path index base weights, e.g., a most critical path in FIG. 8 is Login/Auth and therefore a critical path value of 100 s assigned, while Order/New is assigned a critical path value of 50, and Login/AuthFail is assigned a critical path value of 1.

FIG. 9 depicts a table 900, in accordance with one embodiment. As an option, the present table 900 may be implemented in conjunction with features from any other embodiment listed herein, such as those described with reference to the other FIGS. Of course, however, such table 900 and others presented herein may be used in various applications and/or in permutations which may or may not be specifically described in the illustrative embodiments listed herein. Further, the table 900 presented herein may be used in any desired environment.

The table 900 indicates configuration files that are associated with each of the different test cases of a computer code. In some approaches, more than one test case is associated with the same configuration file. Configuration change values are calculated for each of the test cases using techniques described elsewhere herein, e.g., see method 200.

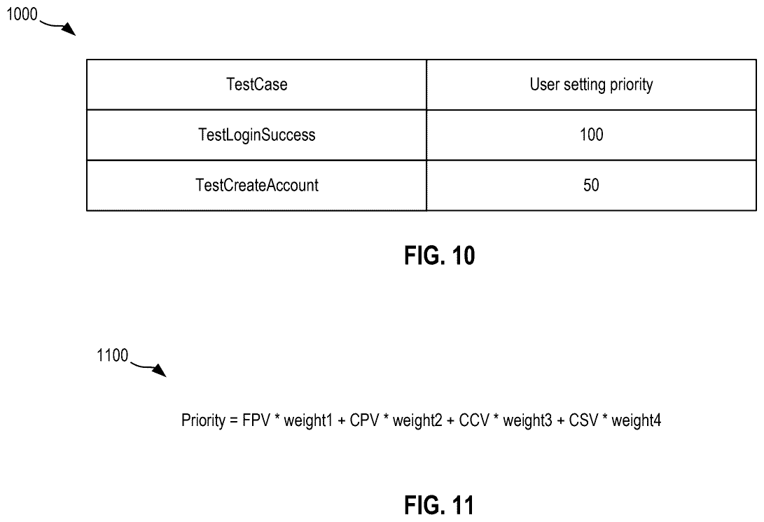

FIG. 10 depicts a table 1000, in accordance with one embodiment. As an option, the present table 1000 may be implemented in conjunction with features from any other embodiment listed herein, such as those described with reference to the other FIGS. Of course, however, such table 1000 and others presented herein may be used in various applications and/or in permutations which may or may not be specifically described in the illustrative embodiments listed herein. Further, the table 1000 presented herein may be used in any desired environment.

Table 1000 includes customized setting values, which are variables that provide adjustments based on input received from a user device.

FIG. 11 depicts an equation 1100, in accordance with one embodiment. As an option, the present equation 1100 may be implemented in conjunction with features from any other embodiment listed herein, such as those described with reference to the other FIGS. Of course, however, such equation 1100 and others presented herein may be used in various applications and/or in permutations which may or may not be specifically described in the illustrative embodiments listed herein. Further, the equation 1100 presented herein may be used in any desired environment.

Equation 1100 may be used to determine priorities of test cases for a computer code. In equation 1100, the variable FPV represents the failure point value of the given test case based on past execution failures of the given test case. The variable CPV represents the critical path value of the given test case which is based on the number of code lines that the given test cases is associated with. Furthermore, the variable CCV represents the configuration change value of configuration files associated with the given test case. Finally, in equation 1100, the variable CSV represents the customized setting value that may be assigned to the given variable based on input received from a user device.

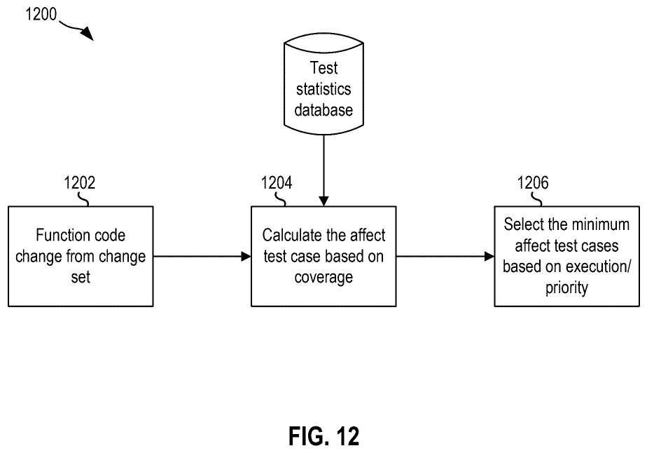

Now referring to FIG. 12, a flowchart of a method 1200 is shown according to one embodiment. The method 1200 may be performed in accordance with aspects of the present invention in any of the environments depicted in FIGS. 1-15, among others, in various embodiments. Of course, more or fewer operations than those specifically described in FIG. 12 may be included in method 1200, as would be understood by one of skill in the art upon reading the present descriptions.

Each of the steps of the method 1200 may be performed by any suitable component of the operating environment. For example, in various embodiments, the method 1200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 1200. Illustrative processors include, but are not limited to, a central processing unit (CPU), an application specific integrated circuit (ASIC), a field programmable gate array (FPGA), etc., combinations thereof, or any other suitable computing device known in the art.

Method 1200 includes operations that may be used to determine a first portion of test cases of computer code to filter out and a second portion of the test cases to run. More specifically, these operations may be used to determine a minimal portion of test cases set to run based on a change (e.g., see operation 1202) to a portion of the computer code, e.g., based on a change set such as a git commit.

Operation 1204 includes using historical data from a test case statistical database to determine how the change to the computer code affects test cases based on coverage. In some approaches, a first AI analysis model may be caused to analyze the historical data to make such a determination. Based on an output of the first AI analysis model, a first AI selection model may be used to select a portion of the test cases to run, e.g., see operation 1206.

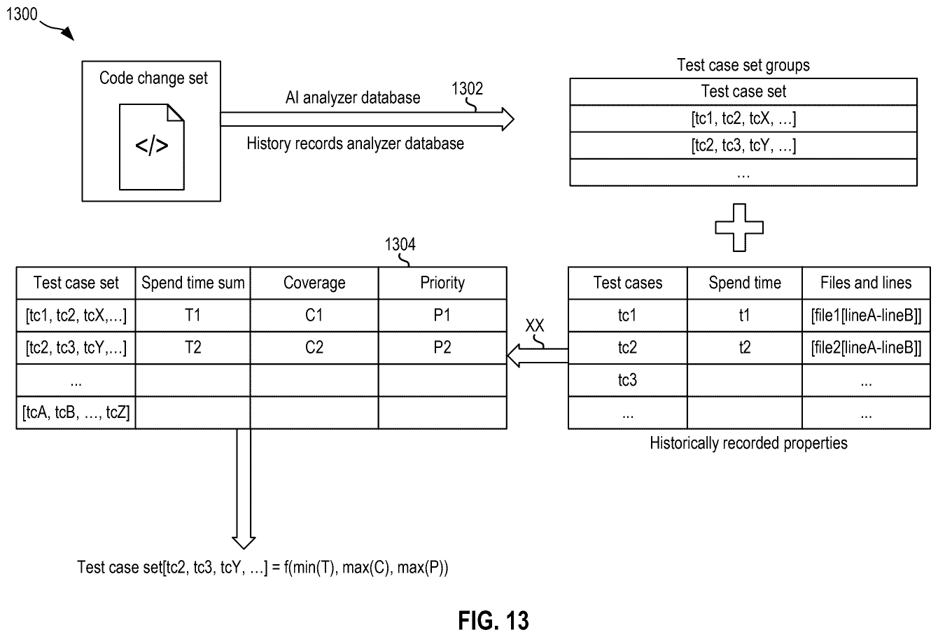

FIG. 13 depicts a progression 1300 of filtration being applied to test cases, in accordance with one embodiment. As an option, the present progression 1300 may be implemented in conjunction with features from any other embodiment listed herein, such as those described with reference to the other FIGS. Of course, however, such progression 1300 and others presented herein may be used in various applications and/or in permutations which may or may not be specifically described in the illustrative embodiments listed herein. Further, the progression 1300 presented herein may be used in any desired environment.

The progression 1300, in some approaches, is initiated in response to a determination that a change has occurred to a computer code, e.g., see code change set. In response thereto, a first AI analysis model is caused to analyze a collection of historical data (e.g., see historically recorded properties) about the computer code, e.g., see operation 1302. In some approaches, the model organizes the test cases based on test and/or functional code relationships determined to exist between the test cases, e.g., see test case set groups which organize test cases with at least a predetermined degree of association with one another.

An output of the first AI analysis model details calculations of priorities of test cases of the computer code, e.g., see table 1304. A first AI selection model is caused to filter a first portion of the test cases from the test cases to establish a second portion of the test cases, where the filtering is based on the calculated priorities, execution times of the test cases, and determined coverages of the test cases. For example, the second portion of the test cases is represented by the Test case set [tc2, tc3, tcY, . . . ], which includes test cases selected based on a minimum spend time, a maximum coverage and a maximum priority.

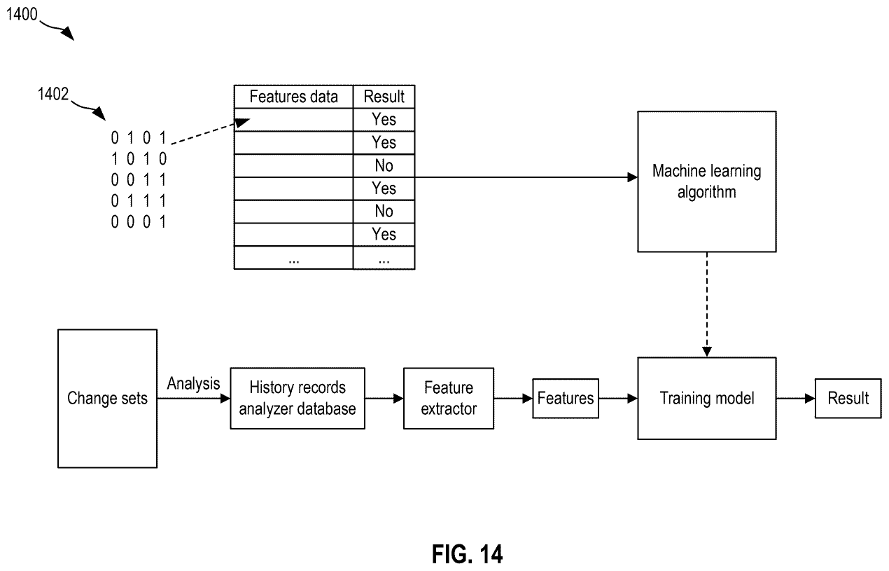

Now referring to FIG. 14, a flowchart of a method 1400 is shown according to one embodiment. The method 1400 may be performed in accordance with aspects of the present invention in any of the environments depicted in FIGS. 1-15, among others, in various embodiments. Of course, more or fewer operations than those specifically described in FIG. 14 may be included in method 1400, as would be understood by one of skill in the art upon reading the present descriptions.

Each of the steps of the method 1400 may be performed by any suitable component of the operating environment. For example, in various embodiments, the method 1400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 1400. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that operations of method 1400 may be used to train AI models to perform techniques described herein. More specifically, operations of method 1400 are performed to train an AI selection model to filter a first portion of test cases from a plurality of test cases to establish a second portion of the test cases to run.

A training set of data 1402 may be evaluated by a machine learning algorithm to provide a training model with context for how to perform the filtering described herein. Furthermore, method 1400 includes developing and maintaining a history record data store based on features extracted (by a feature of a type that would become apparent to one of ordinary skill in the art after reading the descriptions herein) from historical records about a computer code. In some approaches, the historical records about the computer code include information about an analysis performed with respect to changes made to the computer code, e.g., see change sets. The training model uses one or more of these types of information to train the AI selection model until at least a predetermined threshold of accuracy is met, e.g., see result. The trained AI selection model may then be deployed.

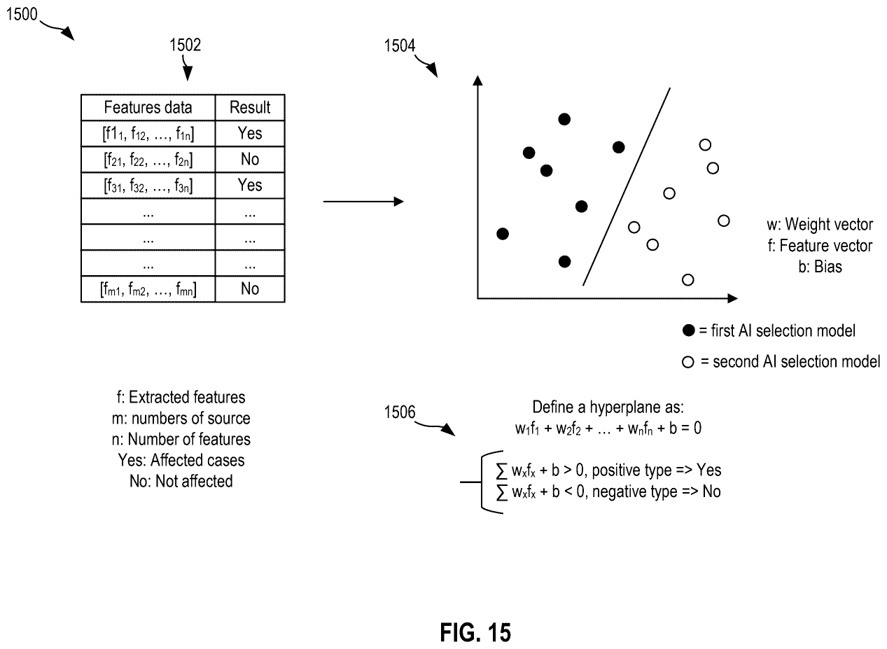

FIG. 15 depicts a modeling 1500, in accordance with one embodiment. As an option, the present modeling 1500 may be implemented in conjunction with features from any other embodiment listed herein, such as those described with reference to the other FIGS. Of course, however, such modeling 1500 and others presented herein may be used in various applications and/or in permutations which may or may not be specifically described in the illustrative embodiments listed herein. Further, the modeling 1500 presented herein may be used in any desired environment.

The modeling 1500 illustrates an evaluation of different AI models with different kernel functions and adjusted parameters to determine a relatively most applicable one of the AI models. In some approaches, one or more of the AI models are multiple hyperplane classification models.

The modeling 1500 illustrates a data source 1502 that is used to generate a plot 1504 of performances of different AI selection models, e.g., see first AI selection model and second AI selection model. Data plotting techniques of a type that would become apparent to one of ordinary skill in the art after reading the descriptions herein may be used. In some approaches, the data source includes a collection portions of test cases that are run based on filtering applied by the different AI selection models. Other variables that the plot may be based on include one or more of, e.g., extracted features, a number of sources that an AI selection model considers, a number of features that an AI selection model considers, etc.

Data points of the different AI selection models within the plot may be used to define a hyperplane that characterizes the AI selection models, e.g., see characterizations 1506. Techniques described elsewhere herein (e.g., see method 200) may be used to determine which of the AI selection models establishes a relatively most efficient portion of the test cases to be run, and the determined AI selection model is preferably deployed for a subsequent filtering of the test cases.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
causing a first artificial intelligence (AI) analysis model to analyze a collection of historical data about a computer code, wherein an output of the first AI analysis model details calculations of priorities of test cases of the computer code;
causing a first AI selection model to filter a first portion of the test cases from the test cases to establish a second portion of the test cases, wherein the filtering is based on the calculated priorities, execution times of the test cases, and determined coverages of the test cases; and
causing the second portion of the test cases to be run.

2. The method of claim 1,
wherein the first AI analysis model is caused to analyze the collection of historical data about the computer code in response to at least one portion of the computer code being changed, and further comprising:
determining, based on results of running the second portion of the test cases, whether the change to the at least one portion of the computer code causes errors during execution of the computer code; and
in response to a determination that the change to the at least one portion of the computer code causes errors during the execution of the computer code, causing a mitigating action to be performed to mitigate the errors in a subsequent execution of the computer code.

3. The method of claim 1, further comprising:
generating the historical data about the computer code by performing an initial run of all of the test cases; and
storing the historical data about the computer code in a statistical database.

4. The method of claim 3, further comprising:
generating new historical data about the computer code based on the running of the second portion of the test cases; and
storing the new historical data about the computer code in the statistical database.

5. The method of claim 1, wherein the historical data about the computer code is selected from the group consisting of: past runtimes for the test cases, dates that the test cases were previously run, test case priority data, test case relationship data, pass and/or fail statistics for previous runs of the test cases, lines of the computer code that the test cases are located at, and a test case heat map.

6. The method of claim 1, wherein the priorities of the test cases of the computer code are calculated based on variables selected from the group consisting of: failure point values based on past execution failures of the test cases, critical path values based on code lines that the test cases are associated with, and configuration change values of configuration files associated with the test cases.

7. The method of claim 6, wherein the priorities of the test cases of the computer code are calculated based on a plurality of the variables, wherein different dynamically adjustable weightages are applied to each of the variables, and further comprising:
adjusting the weightages based on results of running the second portion of the test cases.

8. The method of claim 1, further comprising:
causing a second AI selection model to filter a third portion of the test cases from the test cases to establish a fourth portion of the test cases,
wherein the second AI selection model applies different kernel functions and adjusted parameters than the first AI selection model;
determining which of the first AI selection model and the second AI selection model establishes a relatively most efficient portion of the test cases to be run; and
deploying the determined AI selection model for a subsequent filtering of the test cases.

9. The method of claim 1, further comprising:
using a first training set of data to train the first AI analysis model to analyze a collection of test data;
in response to a determination that the first AI analysis model achieves at least a predetermined threshold of accuracy, deploying the first AI analysis model to analyze the collection of historical data about the computer code;
using a second training set of data to train the first AI selection model to perform filtering; and
in response to a determination that the first AI selection model achieves at least the predetermined threshold of accuracy, deploying the first AI selection model to filter the first portion of the test cases from the test cases to establish the second portion of the test cases.

10. A computer program product comprising:
one or more computer readable storage media; and
program instructions stored on the one or more storage media to perform operations comprising:
causing a first artificial intelligence (AI) analysis model to analyze a collection of historical data about a computer code, wherein an output of the first AI analysis model details calculations of priorities of test cases of the computer code;
causing a first AI selection model to filter a first portion of the test cases from the test cases to establish a second portion of the test cases, wherein the filtering is based on the calculated priorities, execution times of the test cases, and determined coverages of the test cases; and
causing the second portion of the test cases to be run.

11. The computer program product of claim 10,
wherein the first AI analysis model is caused to analyze the collection of historical data about the computer code in response to at least one portion of the computer code being changed, and wherein the operations further comprise:
determining, based on results of running the second portion of the test cases, whether the change to the at least one portion of the computer code causes errors during execution of the computer code; and
in response to a determination that the change to the at least one portion of the computer code causes errors during the execution of the computer code, causing a mitigating action to be performed to mitigate the errors in a subsequent execution of the computer code.

12. The computer program product of claim 10, wherein the operations further comprise:
generating the historical data about the computer code by performing an initial run of all of the test cases; and
storing the historical data about the computer code in a statistical database.

13. The computer program product of claim 12, wherein the operations further comprise:
generating new historical data about the computer code based on the running of the second portion of the test cases; and
storing the new historical data about the computer code in the statistical database.

14. The computer program product of claim 10, wherein the historical data about the computer code is selected from the group consisting of: past runtimes for the test cases, dates that the test cases were previously run, test case priority data, test case relationship data, pass and/or fail statistics for previous runs of the test cases, lines of the computer code that the test cases are located at, and a test case heat map.

15. The computer program product of claim 10, wherein the priorities of the test cases of the computer code are calculated based on variables selected from the group consisting of: failure point values based on past execution failures of the test cases, critical path values based on code lines that the test cases are associated with, and configuration change values of configuration files associated with the test cases.

16. The computer program product of claim 15,
wherein the priorities of the test cases of the computer code are calculated based on a plurality of the variables,
wherein different dynamically adjustable weightages are applied to each of the variables, and
wherein the operations further comprise: adjusting the weightages based on results of running the second portion of the test cases.

17. The computer program product of claim 10, wherein the operations further comprise:
causing a second AI selection model to filter a third portion of the test cases from the test cases to establish a fourth portion of the test cases,
wherein the second AI selection model applies different kernel functions and adjusted parameters than the first AI selection model;
determining which of the first AI selection model and the second AI selection model establishes a relatively most efficient portion of the test cases to be run; and
deploying the determined AI selection model for a subsequent filtering of the test cases.

18. The computer program product of claim 10, wherein the operations further comprise:
using a first training set of data to train the first AI analysis model to analyze a collection of test data;
in response to a determination that the first AI analysis model achieves at least a predetermined threshold of accuracy, deploying the first AI analysis model to analyze the collection of historical data about the computer code;
using a second training set of data to train the first AI selection model to perform filtering; and
in response to a determination that the first AI selection model achieves at least the predetermined threshold of accuracy, deploying the first AI selection model to filter the first portion of the test cases from the test cases to establish the second portion of the test cases.

19. A computer system comprising:
a processor set;
one or more computer readable storage media; and
program instructions stored on the one or more storage media to cause the processor set to perform operations comprising:
causing a first artificial intelligence (AI) analysis model to analyze a collection of historical data about a computer code, wherein an output of the first AI analysis model details calculations of priorities of test cases of the computer code;
causing a first AI selection model to filter a first portion of the test cases from the test cases to establish a second portion of the test cases, wherein the filtering is based on the calculated priorities, execution times of the test cases, and determined coverages of the test cases; and
causing the second portion of the test cases to be run.

20. The computer system of claim 19,
wherein the first AI analysis model is caused to analyze the collection of historical data about the computer code in response to at least one portion of the computer code being changed, and wherein the operations further comprise:
determining, based on results of running the second portion of the test cases, whether the change to the at least one portion of the computer code causes errors during execution of the computer code; and
in response to a determination that the change to the at least one portion of the computer code causes errors during the execution of the computer code, causing a mitigating action to be performed to mitigate the errors in a subsequent execution of the computer code.
